(19) United States
(12) Patent Application Publication
(10) Pub. No.: US 2026/0338151 A1
(43) Pub. Date: Oct. 29, 2026

(54) Method and Device for Operating an Internal Combustion Engine

(71) Applicant: Bayerische Motoren Werke Aktiengesellschaft, Muenchen (DE)

(72) Inventors: Winfried KUFFNER, Muenchen (DE); Peter MUELLER, Muenchen (DE); Stephan RAMATSCHI, Zorneding (DE)

(21) Appl. No.: 19/110,879

(22) PCT Filed: Oct. 16, 2023
(86) PCT No.: PCT/EP2023/078591

§ 371 Date: Mar. 12, 2025

(30) Foreign Application Priority Data
Nov. 17, 2022 (DE) 10 2022 130 449.3

(51) Int. Cl. F02P 5/152

(52) U.S. Cl. CPC F02P 5/152

(57) ABSTRACT

A device for operating an internal combustion engine with a fuel. The device determines a standard ignition angle for an actual operating point of the internal combustion engine on the basis of ignition angle characteristic data, and determines a knock limit distance of the standard ignition angle from a knock limit of the internal combustion engine on the basis of knock limit distance characteristic data for the actual operating point of the internal combustion engine. The device also determines an operating ignition angle for the operation of the combustion engine and/or an actual RON value of the fuel on the basis of the standard ignition angle and on the basis of the knock limit distance.

### BACKGROUND AND SUMMARY

This disclosure relates to a method and a corresponding device which are configured to determine the ignition angle for the operation, in particular for the feedforward control, of an internal combustion engine.

The internal combustion engine, in particular the gasoline engine, of a vehicle is preferably operated as close as possible to the knock limit in order to optimize the efficiency of the internal combustion engine. The knock limit typically depends here on the quality, in particular on the RON number, i.e. on the octane number, of the fuel. A high-quality fuel having a relatively high RON number enables knock-free operation of the internal combustion engine with a relatively early ignition time (i.e. with a relatively “early” ignition angle), by which the efficiency of the internal combustion engine is increased.

To determine the earliest possible ignition time or ignition angle which enables knock-free operation of the internal combustion engine, an ignition angle characteristic map determined in preparation (for example, experimentally and/or on the basis of simulations) can be used. The ignition angle characteristic map can have been determined for a fuel having a relatively high RON number. Furthermore, the ignition angle characteristic map can have been determined for a specific standard temperature (for example, of the fuel, the aspirated air, the coolant, and/or the direct surroundings of the combustion chamber). In general, the ignition angle characteristic map can have been determined for one or more standard boundary conditions. The one or more standard boundary conditions can alternatively be referred to in each case as a design boundary condition (since the ignition angle characteristic map was designed for these one or more boundary conditions).

If the vehicle is operated using a fuel having a lower actual RON number (below the standard RON number for which the ignition angle characteristic map was designed), a delta for correcting the ignition angle specified in the ignition angle characteristic map can be determined on the basis of a knock adaptation. Furthermore, an offset value for the correction of the ignition angle specified in the ignition angle characteristic map can be determined on the basis of a temperature model if the actual temperature of the fuel deviates from the standard temperature (in particular if the actual temperature (for example, of the fuel, the aspirated air, the coolant, and/or the direct surroundings of the combustion chamber) is higher than the standard temperature) It is to be expected that the quality, i.e. the RON number of available fuels will increase further, wherein the increased RON number is to be used as the standard RON number for the ignition angle characteristic map in order to be able to use the efficiency increase of the internal combustion engine enabled by the increased fuel quality in an efficient manner.

However, it has been shown that the ignition angle characteristic map for a fuel having such a high RON number (for example, RON >100) at the standard temperature (for example, at 20 °C) can no longer be experimentally determined at all operating points. In particular, it is no longer possible that certain operating points (for example, due to restrictions of the maximum permissible operating pressure and/or the maximum permissible operating temperature of the internal combustion engine), to set the ignition time or the ignition angle sufficiently early that the knock limit is reached.

The ignition angle characteristic angle determined for a fuel having a particularly high RON number therefore specifies ignition angles at certain operating points (in particular for a relatively high engine load), which are contingent on operating limits (with respect to the operating pressure and/or with respect to the operating temperature) of the internal combustion engine, and which do not correspond to the earliest possible ignition angle at the knock limit. As a result, the internal combustion engine cannot be operated in an efficiency-optimal manner at the certain operating points, even if the actual fuel conditions (in particular the actual temperature (e.g., of the fuel, the aspirated air, the coolant, and/or the direct surroundings of the combustion chamber)) deviate from the standard boundary conditions (in particular from the standard temperature).

The present disclosure relates to the technical problem of enabling efficiency-optimized operation of an internal combustion engine even with fuels having a particularly high RON number, in particular if the true one or more actual boundary conditions deviate from the one or more standard boundary conditions (for which the ignition angle characteristic map was determined).

According to one aspect of the present disclsoure, a device for operating an internal combustion engine (in particular a gasoline engine) using a fuel (in particular using gasoline) is described. The fuel has an actual RON value. The device can be intended to determine the operating ignition angle, using which the internal combustion engine can be operated in the most efficiency-optimized manner possible upon use of a fuel having the actual RON value. The operating ignition angle can be used for the feedforward control (of the ignition angle) of the internal combustion engine (in particular the ignition angle regulation of the internal combustion engine).

The device is configured to determine a standard ignition angle on the basis of ignition angle characteristic data for the (currently present) actual operating point of the internal combustion engine. The actual operating point can be defined by a combination of an actual load and an actual speed. The ignition angle characteristic data can specify the standard ignition angle for each of a plurality of different possible operating points. The ignition angle characteristic data can have been determined experimentally and/or on the basis of simulations in preparation for the operation of the internal combustion engine. Different ignition angle characteristic data can optionally be provided in each case for different operating modes of the internal combustion engine (e.g., Valvetronic operation (load control via valve stroke), standard operation, throttle operation, Miller operation, etc.).

The ignition angle characteristic data can be based on one or more standard boundary conditions for the operation of the internal combustion engine. Exemplary standard boundary conditions are a standard temperature (e.g., of the fuel, the aspirated air, the coolant, and/or the direct surroundings of the combustion chamber) and/or a standard lambda value (i.e. a standard ratio of the amount of combustion air to the amount of fuel in the combustion chamber of the internal combustion engine).

Furthermore, the ignition angle characteristic data can be based on the operation of the internal combustion engine using fuel which has a standard RON value. The standard RON value can alternatively also be referred to as a design RON value, since the ignition angle characteristic data were designed for the standard RON value (i.e. for the design RON value). The ignition angle characteristic data can have been determined with the goal of providing a standard ignition angle for each of the plurality of possible operating points of the internal combustion engine, which is at the knock limit of the internal combustion engine (if the one or more standard boundary conditions are present). The ignition angle characteristic data can therefore have been determined in such a way that the ignition angle characteristic data if possible specify, for each of the individual operating points, the ignition angle which, upon use of a fuel having the standard RON value and upon the presence of the one or more standard boundary conditions, is directly at the knock limit of the internal combustion engine and/or which enables efficiency-optimized operation of the internal combustion engine.

However, the standard RON value can be sufficiently high that due to one or more physical limiting values of the internal combustion engine (for example, a pressure limiting value and/or a temperature limiting value), the ignition angle characteristic data specify, for each of at least a part of the plurality of possible operating points, a standard ignition angle which has an ignition angle delta from the knock limit of the internal combustion engine (upon the presence of the one or more standard boundary conditions). In other words, it can be that the internal combustion engine cannot be operated directly at the knock limit upon the use of a fuel having a relatively high standard RON value (for example, RON>100) at least for a part of the possible operating points (in particular at a relatively high engine load). As a result, the ignition angle characteristic data do not specify the respective ignition angle at the knock limit for this part of the possible operating points, but rather an ignition angle which is spaced apart from the knock limit by a certain ignition angle delta.

The device is furthermore configured to determine a knock limit distance (in particular an ignition angle delta) of the standard ignition angle from the knock limit of the internal combustion engine on the basis of knock limit distance characteristic data for the actual operating point of the internal combustion engine. The knock limit distance can specify the ignition angle delta by which the standard ignition angle at the actual operating point of the internal combustion engine deviates from the knock limit of the internal combustion engine (upon the presence of the one or more actual boundary conditions or upon the presence of the one or more standard boundary conditions) (and by which the standard ignition angle could be set “earlier” more before the knock limit of the internal combustion engine is reached).

The knock limit distance characteristic data can specify the knock limit distance for each of the plurality of possible operating points of the internal combustion engine. The knock limit distance characteristic data can have been determined experimentally and/or on the basis of simulations in preparation for the operation of the internal combustion engine. Different knock limit distance characteristic data can optionally be provided in each case for different operating modes of the internal combustion engine (e.g., Valvetronic operation (load control via valve stroke), standard operation, throttle operation, Miller operation, etc.).

The device can be configured to determine the knock limit distance of the standard ignition angle from the knock limit of the internal combustion engine as a function of the one or more actual boundary conditions, in particular as a function of the deviation of the one or more actual boundary conditions from the one or more corresponding standard boundary conditions. The knock limit distance can thus be determined in a particularly precise manner.

Furthermore, the device is configured to determine the operating ignition angle for the operation of the internal combustion engine and/or the actual RON value of the fuel on the basis of the standard ignition angle and on the basis of the knock limit distance. Due to the consideration of a knock limit distance, which depends on the ignition angle delta of the standard ignition angle from the knock limit of the internal combustion engine, even with particularly high-quality fuels (having a particularly high actual RON value), an efficiency-optimized operation of the internal combustion engine can be effectuated efficiently and reliably (at least if the one or more actual boundary conditions deviate from the one or more corresponding standard boundary conditions).

The device can be configured to determine the one or more (currently present) actual boundary conditions for the operation of the internal combustion engine, wherein the one or more actual boundary conditions deviate at least partially from the one or more corresponding standard boundary conditions. An offset value can then be determined on the basis of a correction unit, which is in particular model-based, and on the basis of the one or more actual boundary conditions. The operating ignition angle for the operation of the internal combustion engine and/or the actual RON value of the fuel can then also be determined in a particularly precise manner on the basis of the offset value. The efficiency of the internal combustion engine can thus be increased further.

The device can be configured to determine an adaptation ignition angle delta of the standard ignition angle from the knock limit of the internal combustion engine (upon the presence of the one or more actual boundary conditions) on the basis of a knock adaptation (for example, on the basis of a knock regulation). The one or more limiting values of the internal combustion engine can be taken into consideration here in the scope of the knock adaptation. In particular, it is possible to have the effects that the one or more limiting values of the internal combustion engine are not exceeded in the scope of the knock adaptation. This can have the results (upon the use of a fuel having a relatively high actual RON value) that the actual knock limit of the internal combustion engine is not reached in the scope of the knock adaptation.

The operating ignition angle for the operation of the internal combustion engine and/or the actual RON value of the fuel can also be determined in a particularly precise manner on the basis of the adaptation ignition angle delta. The device can be configured in particular to reduce the standard RON value by a first delta RON value dependent on the adaptation ignition angle delta and to increase it by a second delta RON value dependent on the knock limit distance in order to determine the actual RON value of the fuel. The actual RON value of the fuel can thus be determined in a particularly precise manner.

The device can therefore be configured to determine the actual RON value of the fuel, using which the internal combustion engine is operated. The Actual RON value can be compared to a RON threshold value (wherein the RON threshold value is possibly different for different operating points of the internal combustion engine). It can then be decided depending on the comparison whether or not the knock limit distance is taken into consideration in the determination of the operating ignition angle. The device can be configured in particular to consider the knock limit distance in the determination of the operating ignition angle, in particular to take it into consideration only if the actual RON value is equal to or greater than the RON threshold value. The reliability of the operation of the internal combustion engine (in particular with respect to knock-free operation of the internal combustion engine) can thus be increased further in an efficiency-optimized manner.

According to a further aspect, a (road) motor vehicle (in particular a passenger vehicle or a truck or a bus or a motorcycle) is described, which comprises the device described in this disclosure.

According to a further aspect, a method for operating an internal combustion engine using a fuel (in particular using gasoline) is described. The method comprises determining, on the basis of ignition angle characteristic data, a standard ignition angle for an actual operating point of the internal combustion engine, and determining, on the basis of knock limit distance characteristic data and for the actual operating point of the internal combustion engine, a knock limit distance of the standard ignition angle from the knock limit of the internal combustion engine. Furthermore, the method comprises determining the operating ignition angle for the operation of the internal combustion engine and/or the actual RON value of the fuel on the basis of the standard ignition angle and on the basis of the knock limit distance.

According to a further aspect, a software (SW) program is described. The SW program can be configured to be executed on a processor (for example, on a control unit of a vehicle), and to thus carry out the method described in this disclosure.

According to a further aspect, a storage medium is described. The storage medium can comprise a SW program, which is configured to be executed on a processor, and to thus carry out the method described in this disclosure.

It is to be noted that the methods, devices, and systems described in this disclosure can be used both alone and in combination with other methods, devices, and systems described in this disclosure. Furthermore, any aspects of the methods, devices, and systems described in this disclosure can be combined with one another in a variety of ways. In particular, the features of the claims can be combined with one another in a variety of ways. Furthermore, features set forth between parentheses are to be understood as optional features.

### BRIEF DESCRIPTION OF THE DRAWINGS

The disclosure is described in more detail hereinafter on the basis of exemplary embodiments.

FIG. 1a shows exemplary components of a vehicle having an internal combustion engine;

FIG. 1b shows an exemplary ignition angle characteristic map;

FIG. 1c shows an exemplary device for determining the ignition angle or the ignition time for the operation of an internal combustion engine:

FIG. 2 shows a device for determining the ignition angle or the ignition time for the operation of an internal combustion engine if fuels having a particularly high RON number are taken into consideration; and,

FIG. 3 shows a flow chart of an exemplary method for determining the ignition angle for the operation of an internal combustion engine.

### DETAILED DESCRIPTION OF THE DRAWINGS

As described at the outset, the present disclosure relates to increasing the efficiency of an internal combustion engine in the case of operation using a fuel which has a particularly high RON number (for example, RON >100). In this context, Figure la shows an exemplary vehicle 100 having an internal combustion engine 102, which is designed to drive the vehicle 100 and which is operated using a fuel (for example, using gasoline). A (control) device 101 of the vehicle 100 can be configured to determine the ignition angle for the operation of the internal combustion engine 102. The (control) device 101 may comprise a processor, a storage medium, and software (SW) stored on the storage medium, for purposes of carrying out the method described in this disclosure. It is to be noted that the terms ignition angle and ignition time are used exchangeably in this disclsoure.

The vehicle 100 comprises one or more sensors 104, which are configured to determine one or more operating conditions for the operation of the internal combustion engine 102 (i.e. the operating point of the internal combustion engine 102), such as the load and/or the speed of the internal combustion engine 102. Furthermore, the vehicle 100 can comprise one or more sensors 103, which are configured to detect one or more actual boundary conditions for the operation of the internal combustion engine 102, such as the temperature (e.g., of the fuel, the aspirated air, the coolant, and/or the direct surroundings of the combustion chamber). The device 101 can be configured to determine the ignition angle for the operation of the internal combustion engine 102 as a function of the operating point of the internal combustion engine 102 and/or as a function of the one or more actual boundary conditions.

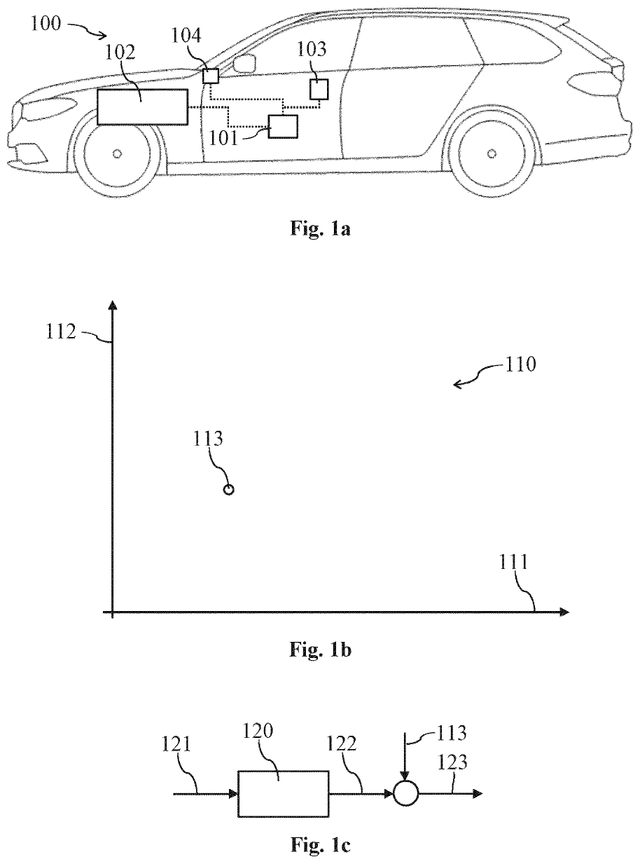

FIG. 1b shows an exemplary ignition angle characteristic map 110, which has been determined (for example, experimentally and/or on the basis of a simulation) in preparation for the operation of the internal combustion engine 102. The ignition angle characteristic map 110 specifies a standard ignition angle 113 in each case for a combination of one or more operating parameters (for example, the load 112 and/or the speed 111) of the internal combustion engine 102 (i.e. for an operating point of the internal combustion engine 102). The ignition angle characteristic map 110 can have been determined for a fuel which has a standard RON value. Furthermore, the ignition angle characteristic map 110 can have been determined for one or more standard boundary conditions. The standard ignition angle 113 can in this case be the earliest-possible ignition angle upon use of a fuel having the standard RON value and upon the presence of the one or more standard boundary conditions, so that efficiency-optimized operation of the internal combustion engine 102 is effectuated.

If the fuel used during the operation has the standard RON value and if the one or more standard boundary conditions are present, the internal combustion engine 102 can then be operated using the standard ignition angle 113. On the other hand, if the actual RON value deviates from the standard RON value and/or the one or more actual boundary conditions deviate from the one or more corresponding standard boundary conditions, an adaptation of the standard ignition angle 113 is thus typically necessary in order to still effectuate efficiency-optimized operation of the internal combustion engine 102.

FIG. 1c illustrates an exemplary adaptation of the standard ignition angle 113. An offset value 122, using which the standard ignition angle 113 can be adjusted, in particular can be adjusted (later), can be determined on the basis of a correction unit 120, in order to determine the operating ignition angle 123 for the operation of the internal combustion engine 102. The (model-based) correction unit 120 can be configured to determine the offset value 122 on the basis of the one or more actual boundary conditions 121 (in particular on the basis of the actual temperature (e.g., of the fuel, the aspirated air, the coolant, and/or the direct surroundings of the combustion chamber)) and/or on the basis of the actual RON value. The adaptation of the standard ignition angle 113 described in conjunction with FIG. 1c is based on the assumption that the actual RON value of the fuel is always less than the standard RON value (i.e. than the design RON value).

The development of novel fuels has the result that fuels become available which have a particularly high RON value (for example, RON>100). As a result, the standard or design RON value increases, for which an ignition angle characteristic map 110 is to be determined and stored in the vehicle 100. As described at the outset, the internal combustion engine 102 typically has one or more limiting values, which are not supposed to be exceeded during operation of the internal combustion engine 102, for example, a pressure limiting value, for example, for the pistons, for the big end bearings, for the spark plugs, etc., and/or a temperature limiting value, for example, for the pistons, for the big end bearings, for the spark plugs, etc. This in turn has the result that if a fuel having a relatively high standard RON value is used and if the one or more standard boundary conditions are present at least for a part of the possible operating points, an efficiency-optimized standard ignition angle 113 cannot be determined (which is at the knock limit of the internal combustion engine 102). For these operating points, a standard ignition angle 113 is then typically stored in each case in the characteristic map 110, which results by way of the one or more limiting values of the internal combustion engine 102.

If the internal combustion engine 102 is operated using a fuel which has an actual temperature that deviates from the standard temperature, in particular which is higher than the standard temperature, an offset value 122 is determined by the correction unit 120, by which the standard ignition angle 113 from the ignition angle characteristic map 110 is increased, i.e. adjusted in the direction “later”. Such a correction of the standard ignition angle 113 is possibly not necessary if the standard ignition angle 113 specified by the characteristic map 110 is not at the knock limit due to the relatively high standard RON value. As a result thereof, the internal combustion engine 102 is not operated in an efficiency-optimized manner in the event of an actual boundary condition 121 (in particular at an actual temperature (e.g., of the fuel, the aspirated air, the coolant, and/or the direct surroundings of the combustion chamber)), which deviates from the corresponding standard boundary condition.

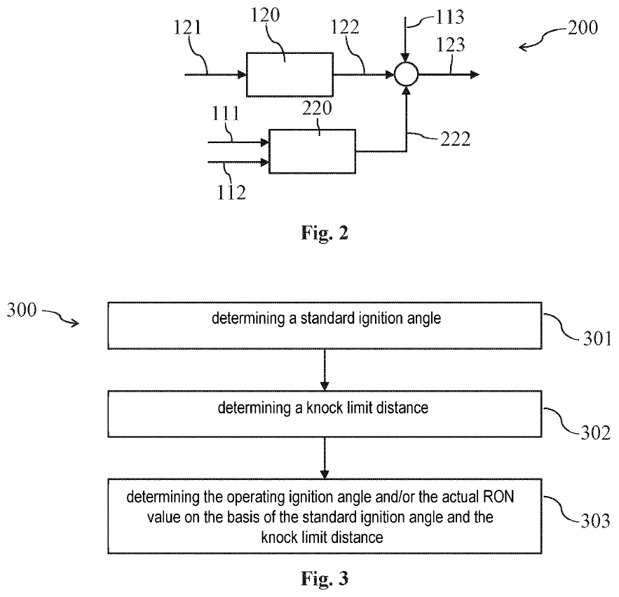

FIG. 2 shows an exemplary device 200, which enables an efficiency-optimized operation of the internal combustion engine 102 to be allowed even starting from an ignition angle characteristic map 110 for a fuel having a particularly high standard RON value. The device 200 comprises for this purpose a compensation unit, which is configured to determine a knock limit distance 222 for each of the different operating points (in particular for different combinations of load 112 and speed 111) of the internal combustion engine 102. The compensation unit can be based on a compensation or knock distance characteristic map 220 determined in preparation, which specifies the knock limit distance 222 for each of the different operating points.

The knock limit distance 222 for an operating point can depend on how much the standard ignition angle 113 specified by the ignition angle characteristic map 110 (on the basis of the one or more limiting values of the internal combustion engine 102) deviates from the knock limit (and therefore from an efficiency-optimized operation of the internal combustion engine 102). The knock limit distance 222 can be different for different operating points (and possibly for different operating modes of the internal combustion engine 102). The compensation characteristic map 220 for determining the respective knock limit distance 222 can have been determined (experimentally and/or on the basis of simulation) in preparation for the operation of the internal combustion engine 102.

An offset value 122 for the standard ignition angle 113 specified by the ignition angle characteristic map 110 (for the current operating point) can therefore be determined on the basis of the one or more actual boundary conditions 121. Furthermore, the knock limit distance 222 can be determined for the current operating point of the internal combustion engine 102 (possibly in consideration of the one or more actual boundary conditions 121). The standard ignition angle 113 can then be adapted based on the offset value 122 and based on the knock limit distance 222 in order to determine the operating ignition angle 123 for the operation (in particular for the feedforward control) of the internal combustion engine 102. For example, the operating ignition angle 113 ZB can be determined as Z_{B}=Z_{N}+O−K, wherein Z_{N} is the standard ignition angle 113, wherein O is offset value 122, and wherein K is the knock limit distance 222.

As described at the outset, an internal combustion engine 102 is to be operated in an efficiency-optimal manner at the knock limit in the entire operating range (i.e. for all operating points). The knock resistance of fuels (i.e. the RON value of fuels) is increasing further due to technical improvements in the production. The measures described in this disclosure enable the efficiency-related potentials which these fuels offer with respect to knock resistance to be used in an efficient and reliable manner.

The quality, i.e. the actual RON value, of the currently used fuel can be concluded by a control and/or regulation method during operation of the internal combustion engine 102 on the basis of a measurement of the knock limit (which is identified via a knock identification and regulation). The feedforward control of the ignition (i.e. the operating ignition angle 123) can be corrected in a matching manner using this determined fuel quality. Moreover, a model for the correction of the ignition feedforward control (i.e. for determining the operating ignition angle 123) can be used, which takes into consideration the intake temperature (i.e. the actual temperature) and/or the engine temperature.

If the ignition cannot be selected as early as possible unrestrictedly for the fuel in the entire characteristic map range (for example, because otherwise the component temperature limit of the spark plugs will be exceeded), the measured knock limit is typically no longer informative with respect to the quality (in particular with respect to the actual RON value) of the fuel used. These operating ranges of the internal combustion engine 102 therefore cannot be taken into consideration in the determination of the fuel quality, so that a determination of the fuel quality is not possible in these ranges.

As already described, if very knock-resistant fuels are used (RON values>100), the knock limit is possibly no longer measurable in the high-load range, since at boundary conditions favorable for the tendency toward knocking (low ambient and engine temperatures), otherwise maximum permissible pressures in the combustion chamber (i.e. limiting values of the internal combustion engine 102) are exceeded, in particular at the one or more standard boundary conditions. These maximum permissible pressures are defined, for example, via the component strength limits of the components participating in the combustion (e.g., components of the piston assembly and/or the spark plug and/or the big end bearing, etc.) as well as components of the valve drive and crank drive. A general use and/or a fault-free function of the fuel quality identification described above is therefore no longer possible due to the required distance to the knock limit.

At knock-critical actual boundary conditions due to elevated temperatures (for example, of the fuel, the intake air, and/or the engine 102), the ignition is typically corrected (by the correction unit 120) in the direction of later. If, upon use of a fuel having a relatively high octane number, the same later position of the ignition angle is used in operating points in which (with the one or more standard boundary conditions present) a knock limit distance is present to maintain the maximum permissible pressures (i.e. the one or more limiting values of the internal combustion engine 102), the fuel efficiency potential is not utilized. The consumption and/or CO₂ emissions and/or exhaust gas temperatures of the internal combustion engine 102 therefore typically increase, although this would not be required with actual boundary conditions which deviate from the standard boundary conditions.

As described above, the knock adaptation can forward an offset 122 matching with the currently used fuel quality to the ignition feedforward control. This offset 122 can additionally be corrected by the knock limit distance 222 (for example, in the form of a value which is read from a speed/load dependent characteristic map 220). Therefore, even in operating ranges in which the knock limit cannot be approached with all fuels (for example, because of maximum permissible pressure limits in the combustion chamber), a fuel quality determination can take place or the fuel quality can be calculated correctly continuously.

Alternatively or additionally, the correction of the ignition feedforward control (for example, a correction due to a deviation from a standard boundary condition, such as a standard temperature) can be offset with the knock limit distance 222 in order to determine the operating ignition angle 123. This can possibly only be effectuated if a specific activation condition is met. An exemplary activation condition is that it is recognized on the basis of the knock adaptation that the actual RON value of the fuel reaches or exceeds a certain RON threshold value (wherein the RON threshold value can be different for different operating points of the internal combustion engine 102). Due to the consideration of the knock limit distance 222, the RON potential of a high-octane fuel can be utilized completely for minimizing CO2 and/or consumption and/or negative effects due to degradation measures can be reduced to a minimum.

FIG. 3 shows a flow chart of a (possibly computer-implemented) method 300 for operating an internal combustion engine 102 using a fuel, wherein the fuel has an actual RON value. The method 300 can in particular be designed to determine the operating ignition angle 123 for the operation (in particular for the feedforward control of the ignition angle regulation) of the internal combustion engine 102.

The method 300 comprises determining 301, on the basis of ignition angle characteristic data 110 (determined in preparation), a standard ignition angle 113 for the (currently present) actual operating point of the internal combustion engine 102. The ignition angle characteristic data 110 can specify a standard ignition angle 113 for each of a plurality of different possible operating points. One possible operating point can possibly correspond to a combination of load 112 and speed 111 of the internal combustion engine 102. The ignition angle characteristic data 110 can have been determined for a fuel which has a standard RON value. Furthermore, the ignition angle characteristic data 110 can have been determined for the operation of the internal combustion engine 102 upon the presence of one or more standard boundary conditions (for example, upon the presence of a standard temperature of the fuel and/or the intake air, upon the presence of a standard temperature of the internal combustion engine and/or upon the presence of a standard lambda value (i.e. a standard ratio of combustion air and fuel)).

During the current operation of the internal combustion engine 102, one or more actual boundary conditions can be present which deviate from the one or more corresponding standard boundary conditions.

The method 300 furthermore comprises determining 302, on the basis of knock limit distance characteristic data 220 and for the actual operating point of the internal combustion engine 102, a knock limit distance 222 of the standard ignition angle 113 from the knock limit of the internal combustion engine 102. The knock limit distance 222 can specify the ignition angle delta, by which the standard ignition angle 113 deviates in the (current) actual operating point (and upon the presence of the one or more actual boundary conditions) from the knock limit of the internal combustion engine 102. The knock limit distance 122 can depend here on the one or more actual boundary conditions, in particular on the deviation of the one or more actual boundary conditions from the one or more corresponding standard boundary conditions.

Furthermore, the method 300 comprises determining 303 an operating ignition angle 123 for the operation of the internal combustion engine 102 and/or the actual RON value of the fuel on the basis of the standard ignition angle 113 and on the basis of the knock limit distance 222.

The measures described in this disclosure enable an efficiency-optimized operation of the internal combustion engine 102 to be effectuated even with fuels having a particularly high RON value in an efficient and reliable manner.

The present disclosure is not restricted to the exemplary embodiments shown. In particular, it is to be noted that the description and the figures are only to illustrate the principle of the proposed methods, devices, and systems by way of example.

1.-10. (canceled)

11. A device for operating an internal combustion engine using a fuel, the device configured to:
determine a standard ignition angle on the basis of ignition angle characteristic data for an actual operating point of the internal combustion engine;
determine a knock limit distance of the standard ignition angle from a knock limit of the internal combustion engine on the basis of knock limit distance characteristic data for the actual operating point of the internal combustion engine; and,
determine an operating ignition angle for the operation of the internal combustion engine and/or an actual RON value of the fuel on the basis of the standard ignition angle and on the basis of the knock limit distance.

12. The device according to claim 11,
wherein the ignition angle characteristic data are based on one or more standard boundary conditions for the operation of the internal combustion engine; and.
wherein the device is configured to:
determine one or more actual boundary conditions for the operation of the internal combustion engine, wherein the one or more actual boundary conditions deviate at least partially from the one or more corresponding standard boundary conditions;
determine an offset value, on the basis of a correction unit, which is model-based, and on the basis of the one or more actual boundary conditions; and
determine the operating ignition angle for the operation of the internal combustion engine and/or the actual RON value of the fuel on the basis of the offset value.

13. The device according to claim 11, wherein the device is configured to:
determine an adaptation ignition angle delta of the standard ignition angle from the knock limit of the internal combustion engine on the basis of a knock adaptation, if one or more actual boundary conditions are present; and,
determine the operating ignition angle for the operation of the internal combustion engine and/or the actual RON value of the fuel on the basis of the adaptation ignition angle delta.

14. The device according to claim 13, wherein:
the ignition angle characteristic data are based on an operation of the internal combustion engine using fuel which has a standard RON value; and,
the device is configured to reduce the standard RON value by a first delta RON value dependent on the adaptation ignition angle delta and to increase a second delta RON value dependent on the knock limit distance in order to determine the actual RON value of the fuel, with which the internal combustion engine is operated.

15. The device (101) according to claim 11, wherein the device is configured to:
determine the actual RON value of the fuel, with which the internal combustion engine is operated;
compare the actual RON value with an RON threshold value; and,
depending on the comparison, to take into consideration or not to take into consideration the knock limit distance in the determination of the operating ignition angle.

16. The device according to claim 15, wherein the device is configured to take the knock limit distance into consideration in the determination of the operating ignition angle, only if the actual RON value is equal to or greater than the RON threshold value.

17. The device according to claim 11, wherein:
the ignition angle characteristic data are based on one or more standard boundary conditions for the operation of the internal combustion engine;
the one or more standard boundary conditions comprising:
a standard temperature of the fuel;
a standard temperature of the air aspirated by the internal combustion engine;
a standard temperature of coolant for cooling the internal combustion engine; and/or
a standard temperature of the internal combustion engine; and/or a standard lambda value;
the ignition angle characteristic data are based on an operation of the internal combustion engine using fuel which has a standard RON value;
the ignition angle characteristic data were determined with the goal of providing a standard ignition angle, which is at the knock limit of the internal combustion engine if the one or more standard boundary conditions are present, for each of a plurality of possible operating points of the internal combustion engine; and,
the standard RON value is sufficiently high that due to one or more physical limiting values of the internal combustion engine, the ignition angle characteristic data specify a standard ignition angle for at least a part of the plurality of possible operating points, which has an ignition angle delta from the knock limit of the internal combustion engine if the one or more standard boundary conditions are present.

18. The device according to claim 11, wherein the device is configured to:
determine one or more actual boundary conditions for the operation of the internal combustion engine, wherein the one or more actual boundary conditions deviate at least partially from the one or more corresponding standard boundary conditions;
determine the knock limit distance of the standard ignition angle from the knock limit of the internal combustion engine as a function of the one or more actual boundary conditions, including a deviation of the one or more actual boundary conditions from the one or more corresponding standard boundary conditions.

19. The device according to claim 11, wherein the ignition angle characteristic data and/or the knock limit distance characteristic data have been determined experimentally and/or on the basis of simulations in the preparation for the operation of the internal combustion engine.

20. A method for operating an internal combustion engine using a fuel, wherein the method comprises:
determining, on the basis of ignition angle characteristic data, a standard ignition angle for an actual operating point of the internal combustion engine;
determining on the basis of knock limit distance characteristic data and for the actual operating point of the internal combustion engine, a knock limit distance of the standard ignition angle from a knock limit of the internal combustion engine; and,
determining an operating ignition angle for the operation of the internal combustion engine and/or an actual RON value of the fuel on the basis of the standard ignition angle and on the basis of the knock limit distance.
